(19) United States
(12) Patent Application Publication
(10) Pub. No.: US 2025/0391144 A1
(43) Pub. Date: Dec. 25, 2025

(54) INFORMATION PROCESSING DEVICE, SYSTEM, INFORMATION PROCESSING METHOD, INFORMATION PROCESSING PROGRAM, AND COMPUTER SYSTEM

(71) Applicant: Sony Interactive Entertainment Inc., Tokyo (JP)

(72) Inventors: Hidewaki Iwaki, Kanagawa (JP); Naoyuki Miyada, Tokyo (JP)

(73) Assignee: Sony Interactive Entertainment Inc., Tokyo (JP)

(21) Appl. No.: 18/869,719

(22) PCT Filed: Jun. 13, 2022
(86) PCT No.: PCT/JP2022/023579

§ 371 Date: Sep. 8, 2025

(51) Int. Cl. G06V 10/25; G06T 7/20

(52) U.S. Cl. CPC G06V 10/25; G06T 7/20; G06T 2207/20044; G06V 2201/07

(57) ABSTRACT

Provided is an information processing device including a detection section, a setting section, a counting section, an image generation section, and a calculation section. The detection section detects an object according to a first image obtained using a frame-based vision sensor. The setting section sets, in the first image, at least one region of interest including at least a portion of the object. The counting section counts event volume of an event signal in a region of attention corresponding to the region of interest according to an event signal generated by an event-based sensor. The image generation section builds a second image according to the event signal in a case where a predetermined condition is satisfied by the event volume counted by the counting section. The calculation section calculates a motion vector of the region of attention in the second image.

### TECHNICAL FIELD

The present invention relates to an information processing device, a system, an information processing method, an information processing program, and a computer system.

### BACKGROUND ART

Event-based sensors in which pixels generate signals asynchronously upon detection of changes in the intensity of incident light are known. The event-based sensors have the advantage of being able to operate at high speeds with low power consumption compared to frame-based vision sensors that scan all pixels at predetermined intervals, specifically image sensors such as CCD (Charge Coupled Device) sensors and CMOS (Complementary Metal Oxide Semiconductor) sensors. Technologies related to such event-based sensors are described, for example, in PTL 1 and PTL 2.

### CITATION LIST

### Patent Literature

### PTL 1

JP 2014-535098T

### PTL 2

Japanese Patent Laid-open No. 2018-85725.

### SUMMARY

### Technical Problem

Although the above-mentioned advantages of the event-based sensors are well known, their use in combination with other devices has not been fully proposed yet.

Accordingly, an object of the present invention is to provide an information processing device, a system, an information processing method, an information processing program, and a computer system that are able to calculate the motion vectors of various objects with high accuracy by using a frame-based vision sensor and an event-based sensor in a complementary manner.

### Solution to Problem

According to an aspect of the present invention, there is provided an information processing device including a detection section, a setting section, a counting section, an image generation section, and a calculation section. The detection section detects an object according to a first image obtained using a frame-based vision sensor. The setting section sets, in the first image, at least one region of interest including at least a portion of the object. The counting section counts event volume of an event signal in a region of attention corresponding to the region of interest according to the event signal generated by an event-based sensor that asynchronously generates the event signal upon detection of a change in intensity of light incident on each pixel. The image generation section builds a second image according to the event signal in a case where a predetermined condition is satisfied by the event volume counted by the counting section. The calculation section calculates a motion vector of the region of attention in the second image.

According to another aspect of the present invention, there is provided a system including a frame-based vision sensor, an event-based sensor, and an information processing device that includes a detection section, a setting section, a counting section, an image generation section, and a calculation section. The event-based sensor asynchronously generates an event signal upon detection of a change in intensity of light incident on each pixel. The detection section detects an object according to a first image obtained using the frame-based vision sensor. The setting section sets, in the first image, at least one region of interest including at least a portion of the object. The counting section counts event volume of the event signal in a region of attention corresponding to the region of interest. The image generation section builds a second image according to the event signal in a case where a predetermined condition is satisfied by the event volume counted by the counting section. The calculation section calculates a motion vector of the region of attention in the second image.

According to yet another aspect of the present invention, there is provided an information processing method including an acquisition step, a reception step, a detection step, a setting step, a counting step, an image generation step, and a calculation step. The acquisition step acquires a first image obtained using a frame-based vision sensor. The reception step receives an event signal generated by an event-based sensor that asynchronously generates the event signal upon detection of a change in intensity of light incident on each pixel. The detection step detects an object according to the first image. The setting step sets, in the first image, at least one region of interest including at least a portion of the object. The counting step counts event volume of the event signal in a region of attention corresponding to the region of interest. The image generation step builds a second image according to the event signal in a case where a predetermined condition is satisfied by the counted event volume. The calculation step calculates a motion vector of the region of attention in the second image.

According to still another aspect of the present invention, there is provided an information processing program that causes a computer to implement functions of acquiring a first image obtained using a frame-based vision sensor, receiving an event signal generated by an event-based sensor that asynchronously generates the event signal upon detection of a change in intensity of light incident on each pixel, detecting an object according to the first image, setting, in the first image, at least one region of interest including at least a portion of the object, counting event volume of the event signal in a region of attention corresponding to the region of interest, building a second image according to the event signal in a case where a predetermined condition is satisfied by the counted event volume, and calculating a motion vector of the region of attention in the second image.

According to an additional aspect of the present invention, there is provided a computer system including at least one memory for storing a program code and at least one processor for processing the program code to perform operations that include acquiring a first image obtained using a frame-based vision sensor, receiving an event signal generated by an event-based sensor that asynchronously generates the event signal upon detection of a change in intensity of light incident on each pixel, detecting an object according to the first image, setting, in the first image, at least one region of interest including at least a portion of the object, counting event volume of the event signal in a region of attention corresponding to the region of interest, building a second image according to the event signal in a case where a predetermined condition is satisfied by the counted event volume, and calculating a motion vector of the region of attention in the second image.

### BRIEF DESCRIPTION OF THE DRAWINGS

FIG. 1 is a block diagram illustrating a schematic configuration of a system according to an embodiment of the present invention.

FIG. 2 is a diagram illustrating an example of detection in the embodiment of the present invention in a case where an object is a person.

FIG. 3 is a diagram illustrating an example of setting a region of interest in the embodiment of the present invention.

FIG. 4 is another diagram illustrating an example of setting the region of interest in the embodiment of the present invention.

FIG. 5 is another diagram illustrating an example of building event images.

FIG. 6 is a flowchart illustrating an example of a processing method according to the embodiment of the present invention.

FIG. 7 is another diagram illustrating an example of link information.

FIG. 8 is another flowchart illustrating an example of the processing method according to the embodiment of the present invention.

### DESCRIPTION OF EMBODIMENT

An embodiment of the present invention will now be described in detail with reference to the accompanying drawings. In this document and in the accompanying drawings, component elements having substantially the same functional configuration are designated by the same reference signs and will not be redundantly described.

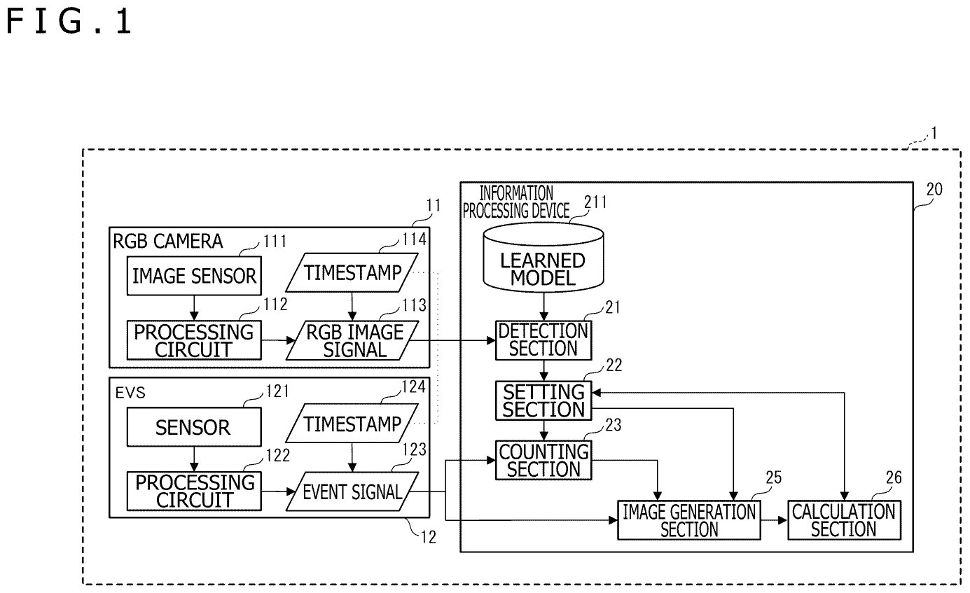

FIG. 1 is a block diagram illustrating a schematic configuration of a system according to the embodiment of the present invention.

A system 1 includes an RGB (Red, Green, Blue) camera 11, an EVS (Event-based Vision Sensor) 12, and an information processing device 20.

The RGB camera 11 includes an image sensor 111 and a processing circuit 112. The image sensor 111 is a frame-based vision sensor. The processing circuit 112 is connected to the image sensor 111. The image sensor 111 generates an RGB image signal 113 by synchronously scanning all pixels at predetermined intervals or at a predetermined timing according to a user operation. The processing circuit 112 converts, for example, the RGB image signal 113 into a format suitable for storage and transmission. Further, the processing circuit 112 attaches a timestamp 114 to the RGB image signal 113.

The EVS 12 is an example of an event-based sensor that generates an event signal upon detection of a change in the intensity of light, and is an example of a sensor referred to as a DVS (Dynamic Vision Sensor) or an EDS (Event Driven Sensor). The EVS 12 includes a sensor 121 and a processing circuit 122. The sensor 121 forms a sensor array. The processing circuit 122 is connected to the sensor 121. The sensor 121 is an event-based sensor that includes a light-receiving element and generates an event signal 123 upon detection of a change in the intensity of light incident on each pixel, or more specifically, a luminance change exceeding a predetermined value. In a case where no change is detected in the intensity of the incident light, the sensor 121 does not generate the event signal 123. In such a case, the event signal 123 is generated asynchronously in the EVS 12. The event signal 123 outputted through the processing circuit 122 includes identification information regarding the sensor 121 (e.g., a pixel location), the polarity of the luminance change (increase or decrease), and a timestamp 124. Further, in a case where a luminance change is detected, the EVS 12 is able to generate the event signal 123 with a frequency significantly higher than the frequency of generation of the RGB image signal 113 (the frame rate of the RGB camera 11).

In the present embodiment, the timestamp 114 attached to the RGB image signal 113 and the timestamp 124 attached to the event signal 123 are synchronized. Specifically, for example, the timestamp 114 can be synchronized with the timestamp 124 by providing the RGB camera 11 with time information used for generation of the timestamp 124 in the EVS 12. Alternatively, in a case where the time information for generating the timestamps 114 and 124 is independent between the RGB camera 11 and the EVS 12, the timestamp 114 and the timestamp 124 can be synchronized afterward by calculating the amount of timestamp offset based on the time of occurrence of a specific event (e.g., a change in a subject across the entire image).

Further, in the present embodiment, a calibration procedure performed in advance between the RGB camera 11 and the EVS 12 associates the sensor 121 of the EVS 12 with one or more pixels of the RGB image signal 113 and generates the event signal 123 according to a change in light intensity at one or more pixels of the RGB image signal 113. More specifically, the sensor 121 can be associated with one or more pixels of the RGB image signal 113, for example, by allowing the RGB camera 11 and the EVS 12 to capture an image of a common calibration pattern and calculating corresponding parameters between the camera and the sensor, from internal parameters and external parameters of the RGB camera 11 and EVS 12.

The information processing device 20 is implemented, for example, by a computer having a communication interface, a processor, and a memory, and includes the functions of a detection section 21, a setting section 22, a counting section 23, an image generation section 25, and a calculation section 26, which are implemented when the processor configured to perform operations by processing a program code operates in accordance with a program that is stored in the memory or received through the communication interface. The functions of the individual sections will be further described below. The detection section 21 is supplied with the RGB image signal 113. The counting section 23 and the image generation section 25 are supplied with the event signal 123.

The detection section 21 detects an object according to the RGB image signal generated by the image sensor 111. The present embodiment is described below with reference to an example in which the object includes a person. The detection section 21 calculates coordinate information regarding at least one joint of the person, which is the object.

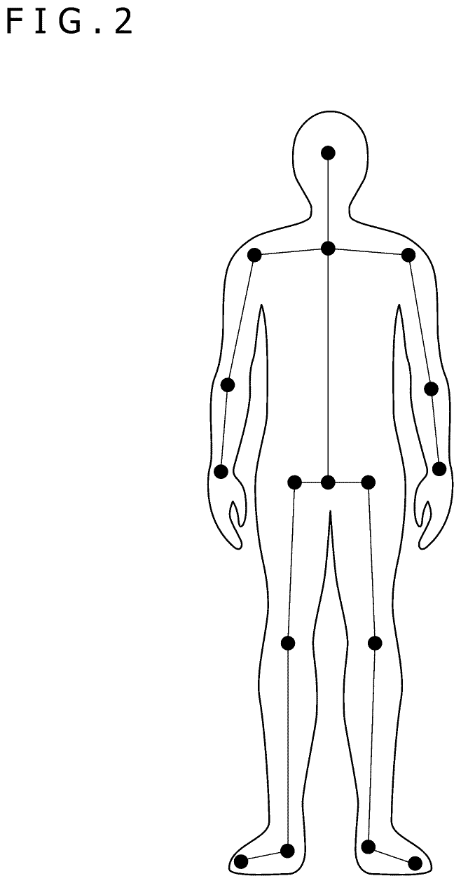

FIG. 2 is a diagram illustrating an example of detection in a case where the object is a person. When the object is a person, the detection section 21 calculates the coordinate information regarding, for example, a plurality of joints of the person as depicted in FIG. 2. FIG. 2 illustrates an example of calculating the coordinate information regarding 17 joints such as a head, shoulders, elbows, wrists, knees, ankles, and toes.

The detection section 21 calculates the coordinate information indicating the positions of the plurality of joints owned by a user from the RGB image signal 113 on the basis of a learned model 211, for example. The learned model 211 can be built in advance by performing supervised learning using, for example, an image of a person having a plurality of joints as input data and coordinate information indicating the positions of the plurality of joints of the person as correct answer data. It is noted that a specific machine learning method will not be described in detail because various known techniques can be used. The detection section 21 may also include a relation learning section that updates the learned model 211 upon each input of the RGB image signal 113 by learning the relation between an image based on an inputted RGB image signal 113 and the coordinate information indicating the positions of the joints.

Further, the event signal 123 may be used during processing by the detection section 21. For example, an object present in a continuous pixel area indicating that events of the same polarity have occurred in the event signal 123 may be detected as a person, and the above-mentioned detection process may be performed on the corresponding portion of the RGB image signal 113.

The setting section 22 sets, in an RGB image based on the RGB image signal 113, a region of interest including at least a portion of the object. The region of interest is a region that includes at least a portion of the object, and is a region of attention that is a target of later-described motion vector calculation.

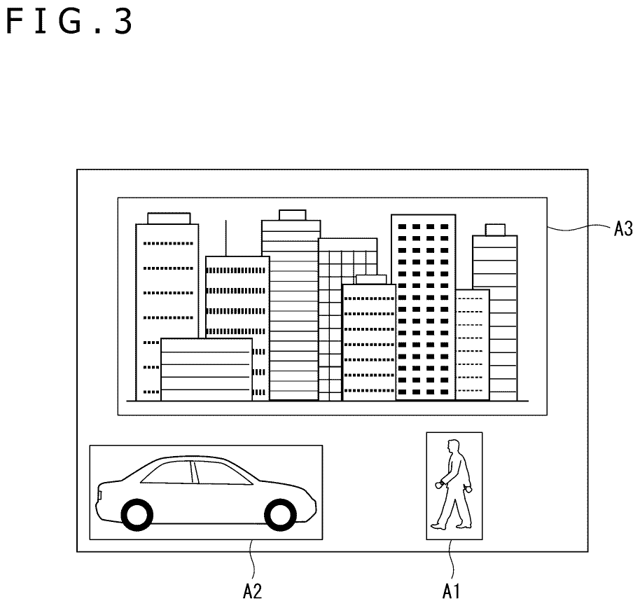

FIG. 3 is a diagram illustrating an example of setting the region of interest. FIG. 3 depicts an example of an RGB image based on the RGB image signal 113. For example, when, as depicted in the example of FIG. 3, a moving person and a moving vehicle are present in the foreground and buildings are present in the background, the person, the vehicle, and the buildings, which are the objects, significantly differ in the amount of movement. Therefore, when an event image is built on the basis of the event signal 123 at uniform time intervals, an object exhibiting a relatively large amount of movement is prioritized. Specifically, in the example of FIG. 3, the event image is built according to an appropriate amount of event signal 123 regarding the vehicle.

In reality, however, for a person exhibiting a relatively small amount of movement, the event image is built before a sufficient amount of event signal 123 is generated. Therefore, the event image does not reflect a sufficient amount of information regarding the event signal 123. This may result in the inability to build an appropriate event image. Further, in a case where the event image is built at uniform time intervals with priority given to an object exhibiting a relatively small amount of movement, information regarding an excessive amount of event signal 123 is reflected in the event image for the vehicle, which is an object exhibiting a relatively large amount of movement. This also results in the inability to build an appropriate event image.

The above-described problem also occurs depending on the texture of the object. For example, in the case of the buildings depicted in FIG. 3, which have reflective surfaces such as windows, and a texture with many irregularities such as decorations, the event signal 123 is frequently generated. This may cause a problem similar to that of the above-described object exhibiting a relatively large amount of movement.

Consequently, the setting section 22 sets a plurality of regions of interest in the RGB image. For instance, in the example of FIG. 3, three regions of interest are set in the RGB image, namely, a region of interest A1 including the person moving slowly, a region of interest A2 including the vehicle moving faster than the person, and a region of interest A3 including the buildings.

It should be noted that the example of FIG. 3 illustrates a case where a plurality of regions of interest including the person, the vehicle, and the buildings are set as objects. Alternatively, however, the setting section 22 may set the regions of interest in more detail on the basis of the result of detection by the detection section 21.

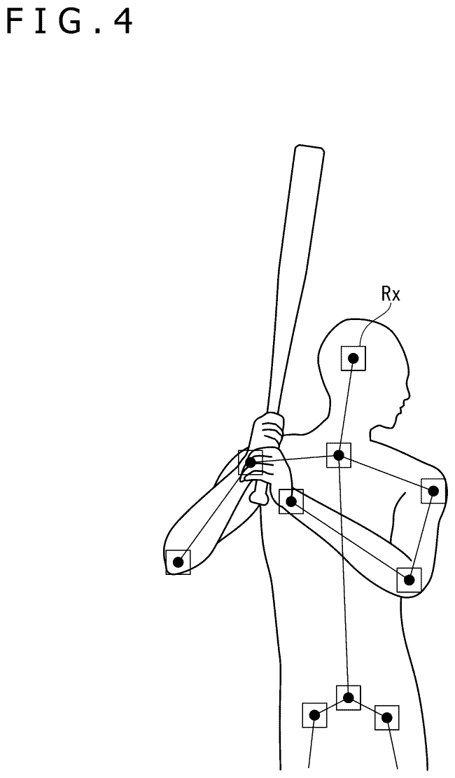

FIG. 4 is another diagram illustrating an example of setting the regions of interest. FIG. 4 depicts an example of the RGB image based on the RGB image signal 113. For example, in a case where the object is a person swinging a baseball bat as depicted in the example of FIG. 4, the arms of the person exhibit a larger amount of movement than the head and torso of the person. If, in such a case, the event image is built at time intervals that prioritize the arms of the person, the event image is built before a sufficient event signal 123 is generated for the head and torso of the person, which exhibit a relatively small amount of movement. Meanwhile, if the event image is built at the time intervals that prioritize the head and torso of the person, which exhibit a relatively small amount of movement, information regarding an excessive amount of event signal 123 is reflected in the event image for the arms of the person, which exhibit a relatively large amount of movement.

Consequently, the setting section 22 sets a plurality of regions of interest in the RGB image. For instance, in the example of FIG. 4, the individual joints of the person, such as the head, the shoulders, the elbows, the wrists, the knees, the ankles, and the toes, are set as objects as described with reference to FIG. 2, and a plurality of regions of interest R1 to Rx including the individual objects are set.

In the example of FIG. 3, a rectangular region of interest is set, and in the example of FIG. 4, a square region of interest is set. However, the shape of the region of interest is not limited to such examples. Further, the user may be allowed to set the details of the region of interest.

As described above, the setting section 22 sets the region of interest each time an RGB image based on the RGB image signal 113 is generated, and outputs information indicating the positions of the set region of interest to the counting section 23, the image generation section 25, and the calculation section 26.

The setting section 22 updates the region of interest upon each event image generation until the RGB image based on the RGB image signal 113 is generated subsequently. The update of the region of interest will be described in detail later.

The counting section 23 counts the event volume of the event signal 123 in the region of attention corresponding to the region of interest according to the event signal 123. Here, the event volume is, for example, the number of event signals 123 per unit time. The counting section 23 counts the number of event signals 123 by regarding each of the plurality of regions of interest set in the RGB image by the setting section 22 as the region of attention. Further, in a case where a predetermined threshold is exceeded by the number of event signals 123, the counting section 23 determines that a predetermined condition is satisfied, and outputs information indicating the result of determination to the image generation section 25.

After completion of determination result output, the counting section 23 resets a counter, and counts the event volume each time the event signal 123 is newly supplied. More specifically, the counting section 23 counts the event volume of the event signal 123 until the predetermined threshold is exceeded by the number of event signals 123 for the first time and until the predetermined threshold is exceeded by the number of event signals 123 after the counter is reset. When the predetermined threshold is exceeded by the number of event signals 123, the counting section 23 resets the counter, and then counts the event volume of the event signal 123 until the predetermined threshold is exceeded by the number of event signals 123. The counting section 23 repeats the above-described series of processes.

Instead of a configuration in which the counter is to be reset, an alternative configuration may be adopted to count the event volume by cumulative addition or by using other methods.

Further, although a case where a predetermined condition is satisfied by the counted event volume is cited as an example of a predetermined condition for building the event image, the predetermined condition for building the event image is not limited to such an example. For example, the event volume is not limited to the above-mentioned number of event signals 123 per unit time. Furthermore, for example, the distribution of the event signal 123 may be calculated by performing a weighting process based, for instance, on the distance from the center of each region of attention to the event signal 123, and then the calculated distribution may be used as the event volume. The distribution may be calculated on a logarithmic scale. Calculating the distribution in a manner described above makes it possible to calculate a distribution that is less affected by changes in the ambient brightness. Particularly, when the distribution is calculated on the logarithmic scale, it is possible to accurately calculate the distribution even in a dark scene where the EVS 12 is not good at calculating the distribution.

The image generation section 25 accumulates the event signals 123 in an undepicted buffer, and builds an event image based on the accumulated event signals 123 according to the determination result that is outputted by the counting section 23 according to the event volume. When the counting section 23 outputs a determination result indicating that the predetermined threshold is exceeded by the number of event signals 123, the image generation section 25 builds an event image based on the event signals 123 accumulated in the buffer. After the event image is built, the image generation section 25 resets the buffer. Subsequently, when the event signal 123 is newly supplied, the image generation section 25 accumulates the newly supplied event signal 123 in the buffer.

As described above, the time intervals suitable for building an event image from the event signal 123 vary depending on the object. In the present embodiment, the setting section 22 sets a plurality of regions of interest, the counting section 23 counts the event volume of each region of attention corresponding to the region of interest, and when the predetermined condition is satisfied by the counted event volume, the image generation section 25 builds an event image. More specifically, when the event image is built by accumulating the event signals 123 for a required period of time that varies from one region of interest to another, the building of the event image is independently executed at different time intervals appropriate for the characteristics of each region of interest, such as the speed of movement and the texture, that is, at different timings.

As a result, the larger the event volume per unit time, the shorter the time required for satisfying the predetermined condition. Therefore, the event image is built at short time intervals. Meanwhile, the smaller the event volume per unit time, the longer the time required for satisfying the predetermined condition. Therefore, the event image is built at long time intervals.

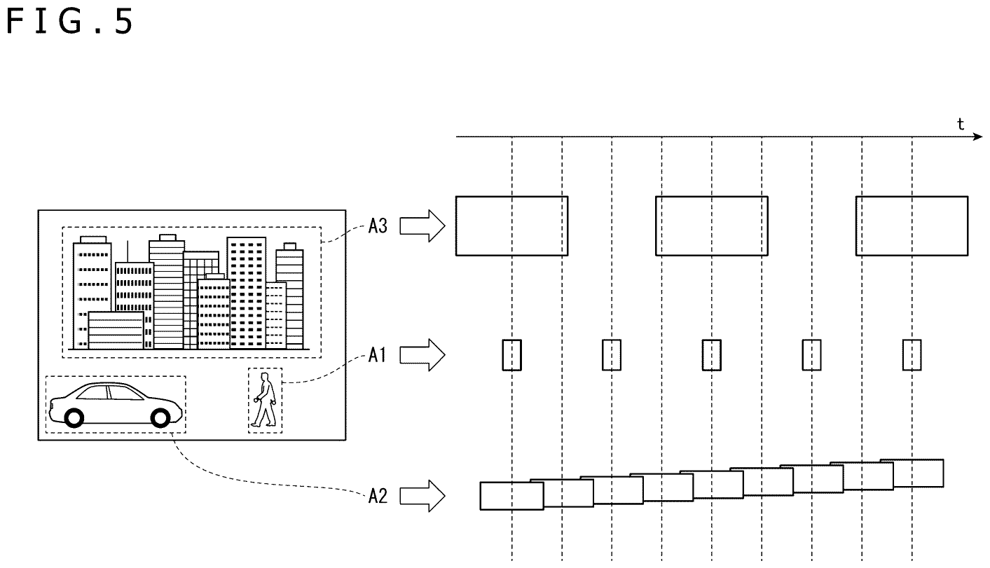

FIG. 5 is a diagram illustrating an example of building the event image. FIG. 5 depicts an example of the event image that is built for each region of attention. For example, as indicated in the example of FIG. 5, the event image is built at time intervals that vary with the characteristics of the region of attention. Consequently, all event images are built on the basis of the event signal 123 having an appropriate event volume.

The calculation section 26 calculates the motion vectors of the regions of attention in the event images built by the image generation section 25. Since various known techniques can be used to calculate the motion vectors, the calculation of the motion vectors will not be described in detail.

The calculation section 26 may calculate the motion vectors according to or in consideration of the time required for the event volume to satisfy the predetermined condition.

Further, the calculation section 26 supplies information indicating the calculated motion vectors to the setting section 22. The setting section 22 updates the regions of interest according to the motion vectors. More specifically, the setting section 22 updates the regions of interest by referencing the motion vectors calculated on the basis of the event images upon each event image generation until the RGB image based on the RGB image signal 113 is generated subsequently. As a result, even before the RGB image based on the RGB image signal 113 is generated, suitable regions of interest can be continuously set by referencing the motion vectors based on the event images.

Furthermore, when an RGB image based on the RGB image signal 113 is generated subsequently, the setting section 22 should set the regions of interest by referencing not only the information regarding the generated RGB image but also the information regarding the current regions of interest, that is, the latest information regarding the regions of interest that is updated on the basis of the motion vectors according to the event images.

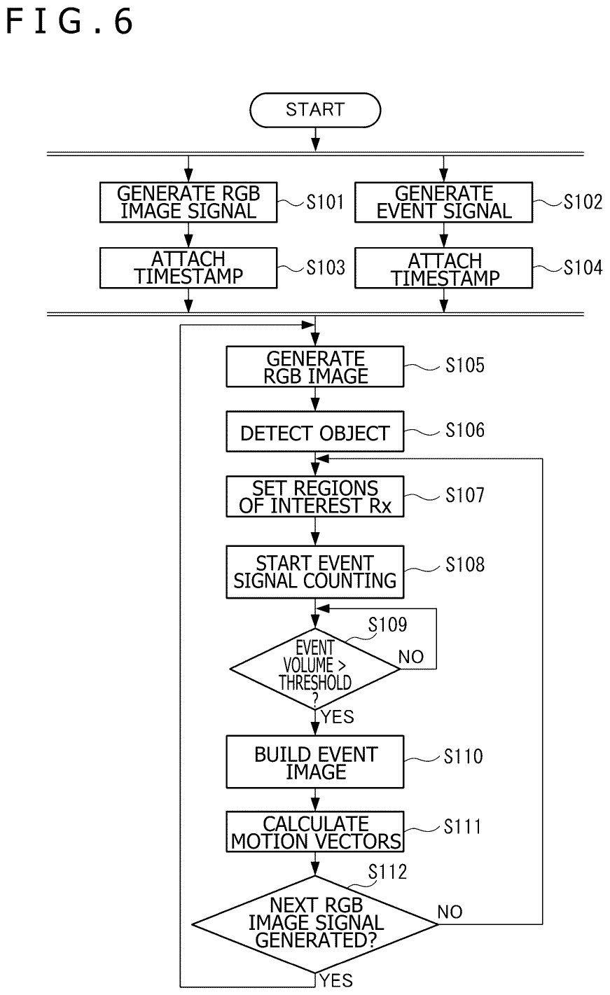

FIG. 6 is a flowchart illustrating an example of processing according to the embodiment of the present invention. In the illustrated example, the RGB camera 11 generates the RGB image signal 113 (step S101), and in parallel with such RGB image signal generation, the EVS 12 generates the event signal 123 (step S102). It should be noted that step S102 of generating the event signal 123 is executed only when a change in light intensity is detected by the sensor 121 associated with one or more pixels of the RGB image signal 113. The timestamp 114 is attached to the RGB image signal 113 (step S103), and the timestamp 124 is attached to the event signal (step S104).

The detection section 21 generates an RGB image (step S105), and detects an object (step S106). Then, the setting section 22 sets the regions of interest (step S107), and the counting section 23 starts counting the event volume of the event signal 123 in the regions of attention corresponding to the regions of interest (step S108).

Subsequently, when the event volume exceeds a threshold (“YES” in step S109), the image generation section 25 builds an event image (step S110).

Then, the calculation section 26 calculates the motion vectors (step S111).

When the next RGB image signal 113 is generated (“YES” in step S112), the processing returns to step S105. More specifically, steps S105 to S112 are performed each time the RGB image signal 113 is generated.

Meanwhile, in a case where the RGB image signal 113 is not generated even after an elapse of a predetermined time (“NO” in step S112), that is, until the next RGB image signal 113 is generated, steps S107 to S111 are performed repeatedly. Consequently, the motion vectors are calculated to update the regions of interest each time the event image is built.

Each section of the information processing device 20 performs the above steps S108 to S111 for each of a plurality of regions of interest that are set or updated in step S107.

Further, each section of the information processing device 20 repeats the above steps S105 to S112 (steps S101 to S104 are also repeated, but not necessarily at the same intervals as steps S105 to S113), thereby setting the region of interest for each object, building an event image at optimal time intervals and timings, and calculating the motion vectors. This makes it possible to accurately calculate the motion vectors of various objects.

The motion vectors calculated by the calculation section 26 may be used in any manner, for example, may be used with a tracking technique. When used with the tracking technique, the motion vectors may be applied to a rendering system that uses the motion of the user to depict a CG (Computer graphics) model, a mirroring system that reproduces the motion of the user by using a robot, or a gaming system that accepts user operations in the same way as a controller. For example, in a case where the present invention is applied to the rendering system, more detailed and highly accurate tracking is possible. This makes it possible to reproduce faster, smoother, and more detailed motion of the CG model.

Further, the present invention can be similarly applied to tracking for detecting, for example, a specific vehicle, a machine, or a living thing other than a person, and tracking for detecting a predetermined marker.

When the motion vectors calculated by the calculation section 26 are used with the tracking technique, the event signal 123 is generated more significantly and frequently than the RGB image signal 113 (the frame rate of the RGB camera 11). Therefore, it is expected that the temporal resolution of tracking will be improved. Moreover, using the RGB image generated by the frame-based vision sensor and the event image generated by the event-based sensor in a complementary manner makes it possible to track an object and build an event image at optimal time intervals and timings for the region of the tracked object.

An example of further utilizing the above-mentioned characteristics will now be described. In a case where the object is, for example, a person having a distinctive shape, it is conceivable that link information according to the mutual relation between a plurality of regions of interest is set to correct the motion vectors in accordance with the link information.

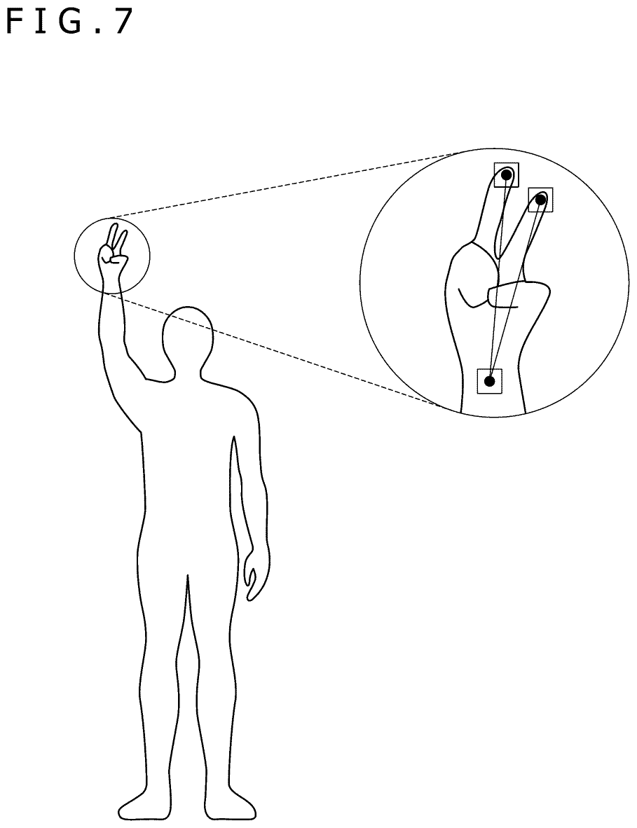

FIG. 7 is another diagram illustrating an example of the link information. For example, in a case where the object is a person waving his/her hand above his/her head as depicted in the example of FIG. 7, a certain mutual relation exists between the tips of fingers and the wrist. Therefore, for example, the link information according to the mutual relation between a plurality of joints of the person is stored in advance, and when the regions of interest are set in the setting section 22, the mutual relation is also set. Subsequently, when the motion vectors are calculated in the calculation section 26, the motion vectors can be corrected on the basis of the link information. For example, in a case where the wrist is moved, it can be presumed that the tips of the fingers are also moved in a substantially similar manner. Consequently, the motion vectors calculated for the regions of interest set at the tips of the fingers can be corrected on the basis of the motion vector calculated for the region of interest set at the wrist.

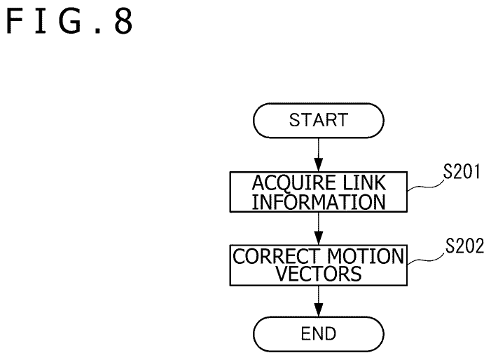

FIG. 8 is a flowchart illustrating another example of processing of the system 1 according to the embodiment of the present invention. The above-mentioned motion vector correction based on the link information is made by performing the following processing between steps S112 and S113 of the processing described with reference to FIG. 6.

In the example of FIG. 8, the link information is acquired (step S201), and the motion vectors are corrected (step S202).

Subsequently, as described with reference to FIG. 6, when the next RGB image signal 113 is generated (“YES” in step S113), the processing returns to step S105 in FIG. 6.

Performing the above-described processing makes it possible to calculate more accurate motion vectors according to the mutual relation between the plurality of regions of interest. Stated differently, it is expected that grouping the plurality of regions of interest will be effective, for example, for accuracy improvement and processing load reduction.

Particularly, in a case where the calculated motion vectors are used with the tracking technique, it is expected that the temporal resolution of tracking will be improved.

The embodiment of the present invention, which has been described above, includes the detection section 21, the setting section 22, the counting section 23, the image generation section 25, and the calculation section 26. The detection section 21 detects an object according to an RGB image (first image) acquired using a frame-based vision sensor. The setting section 22 sets, in the RGB image, at least one region of interest including at least a portion of the object. The counting section 23 counts the event volume of an event signal in a region of attention corresponding to the region of interest according to the event signal generated by an event-based sensor that asynchronously generates the event signal upon detection of a change in the intensity of light incident on each pixel. The image generation section 25 builds an event image according to the event signal in a case where a predetermined condition is satisfied by the event volume counted by the counting section 23. The calculation section 26 calculates the motion vector of the region of attention in the event image.

Consequently, the region of interest can be set for each object, and the event image can be built at optimal time intervals and timings to calculate the motion vector. As a result, the motion vectors of various objects can be accurately calculated. Stated differently, the motion vectors of various objects can be accurately calculated by using the frame-based vision sensor and the event-based sensor in a complementary manner.

Further, in the embodiment of the present invention, the setting section 22 sets a plurality of regions of interest, the counting section 23 counts the event volume of each of regions of attention corresponding to the plurality of regions of interest, the image generation section 25 builds the event image for each of the regions of attention corresponding to the plurality of regions of interest according to a timing to satisfy a predetermined condition, and the calculation section 26 calculates the motion vector of each of the regions of attention corresponding to the plurality of regions of interest. Consequently, the motion vector can be accurately calculated according to the characteristics of each of the plurality of regions of interest.

Furthermore, in the embodiment of the present invention, the setting section 22 sets the link information regarding the plurality of regions of interest according to the mutual relation between the plurality of regions of interest, and the calculation section 26 corrects the motion vector in accordance with the link information. Consequently, it is expected that, for example, improvement of motion vector calculation accuracy and reduction of processing load will be effectively achieved.

Moreover, in the embodiment of the present invention, the calculation section 26 calculates the motion vector according to the time required for the counted event volume to satisfy the predetermined condition. Consequently, it is possible to calculate a motion vector suitable for the characteristics of each region of interest, such as the speed of movement and the texture.

Additionally, in the embodiment of the present invention, the setting section 22 updates the region of interest by referencing the motion vector. Consequently, even before the RGB image based on the RGB image signal 113 is generated, the region of interest can be continuously updated according to the motion vector based on the event image.

Further, in the embodiment of the present invention, the object is a person, the detection section 21 calculates coordinate information regarding at least one joint of the person, and the setting section 22 sets the region of interest for each joint of the person. Consequently, the motion vector of the person regarded as the object can be accurately calculated.

In the above-described example of the detection section 21 of the information processing device 20, a machine learning method is used to detect a detection target from the RGB image signal 113. However, an alternative configuration may be adopted to detect the detection target by using another method instead of or in addition to the machine learning method. For example, the detection target may be detected from the RGB image signal 113 by using a known method such as a block matching method or a gradient method.

Furthermore, the system 1 described in the above example may be implemented in a single device or implemented in a distributed manner in a plurality of devices. For example, the system may be formed by the information processing device 20 and a camera unit including the RGB camera 11 and the EVS 12.

While some embodiments of the present invention have been described in detail above with reference to the accompanying drawings, the present invention is not limited to such foregoing embodiments. It is clear that a person having ordinary knowledge in the technical field to which the present invention pertains can conceive of various changes or modifications within the scope of technical ideas described in the appended claims. It will be understood that such changes and modifications also naturally fall within the technical scope of the present invention.

### SUMMARY OF PRESENT INVENTION

The following is a summary of the present invention.

[1] There is provided an information processing device including a detection section, a setting section, a counting section, an image generation section, and a calculation section. The detection section detects an object according to a first image obtained using a frame-based vision sensor. The setting section sets, in the first image, at least one region of interest including at least a portion of the object. The counting section counts the event volume of an event signal in a region of attention corresponding to the region of interest according to the event signal generated by an event-based sensor that asynchronously generates the event signal upon detection of a change in intensity of light incident on each pixel. The image generation section builds a second image according to the event signal in a case where a predetermined condition is satisfied by the event volume counted by the counting section. The calculation section calculates a motion vector of the region of attention in the second image.

[2] The information processing device described in [1] above is configured such that the setting section sets a plurality of the regions of interest, that the counting section counts the event volume of each of the regions of attention corresponding to a plurality of the regions of interest, that the image generation section builds the second image for each of the regions of attention corresponding to a plurality of the regions of interest according to a timing to satisfy the predetermined condition, and that the calculation section calculates the motion vector of each of the regions of attention corresponding to a plurality of the regions of interest.

[3] The information processing device described in [1] or [2] above is configured such that the setting section sets link information regarding a plurality of the regions of interest according to a mutual relation between a plurality of the regions of interest and that the calculation section corrects the motion vector in accordance with the link information.

[4] The information processing device described in any one of [1] to [3] above is configured such that the event volume indicates the number of event signals per unit time and that the image generation section builds the second image according to the event signals in a case where a predetermined threshold is exceeded by the number of event signals.

[5] The information processing device described in any one of [1] to [4] above is configured such that the calculation section calculates the motion vector according to the time required for the event volume counted by the counting section to satisfy a predetermined condition.

[6] The information processing device described in any one of [1] to [5] above is configured such that the setting section updates the region of interest by referencing the motion vector.

[7] The information processing device described in any one of [1] to [6] above is configured such that the object is a person, that the detection section calculates coordinate information regarding at least one joint of the person, and that the setting section sets the region of interest for each joint of the person.

[8] There is provided a system including a frame-based vision sensor, an event-based sensor, and an information processing device that includes a detection section, a setting section, a counting section, an image generation section, and a calculation section. The event-based sensor asynchronously generates an event signal upon detection of a change in intensity of light incident on each pixel. The detection section detects an object according to a first image obtained using the frame-based vision sensor. The setting section sets, in the first image, at least one region of interest including at least a portion of the object. The counting section counts event volume of the event signal in a region of attention corresponding to the region of interest. The image generation section builds a second image according to the event signal in a case where a predetermined condition is satisfied by the event volume counted by the counting section. The calculation section calculates a motion vector of the region of attention in the second image.

[9] There is provided an information processing method including an acquisition step, a reception step, a detection step, a setting step, a counting step, an image generation step, and a calculation step. The acquisition step acquires a first image obtained using a frame-based vision sensor. The reception step receives an event signal generated by an event-based sensor that asynchronously generates the event signal upon detection of a change in intensity of light incident on each pixel. The detection step detects an object according to the first image. The setting step sets, in the first image, at least one region of interest including at least a portion of the object. The counting step counts event volume of the event signal in a region of attention corresponding to the region of interest. The image generation step builds a second image according to the event signal in a case where a predetermined condition is satisfied by the counted event volume. The calculation step calculates a motion vector of the region of attention in the second image.

[10] There is provided an information processing program that causes a computer to implement functions of acquiring a first image obtained using a frame-based vision sensor, receiving an event signal generated by an event-based sensor that asynchronously generates the event signal upon detection of a change in intensity of light incident on each pixel, detecting an object according to the first image, setting, in the first image, at least one region of interest including at least a portion of the object, counting event volume of the event signal in a region of attention corresponding to the region of interest, building a second image according to the event signal in a case where a predetermined condition is satisfied by the counted event volume, and calculating a motion vector of the region of attention in the second image.

[11] There is provided a computer system including at least one memory for storing a program code and at least one processor for processing the program code to perform operations that include acquiring a first image obtained using a frame-based vision sensor, receiving an event signal generated by an event-based sensor that asynchronously generates the event signal upon detection of a change in intensity of light incident on each pixel, detecting an object according to the first image, setting, in the first image, at least one region of interest including at least a portion of the object, counting event volume of the event signal in a region of attention corresponding to the region of interest, building a second image according to the event signal in a case where a predetermined condition is satisfied by the counted event volume, and calculating a motion vector of the region of attention in the second image.

### REFERENCE SIGNS LIST

1: System
11: RGB camera
12: EVS
20: Information processing device
21: Detection section
22: Setting section
23: Counting section
25: Image generation section
26: Calculation section
111: Image sensor
112, 122: Processing circuit
113: RGB image signal
114, 124: Timestamp
121: Sensor
123: Event signal
211: Learned model

1. An information processing device comprising:
a detection section that detects an object according to a first image obtained using a frame-based vision sensor;
a setting section that sets, in the first image, at least one region of interest including at least a portion of the object;
a counting section that counts event volume of an event signal in a region of attention corresponding to the region of interest according to the event signal generated by an event-based sensor that asynchronously generates the event signal upon detection of a change in intensity of light incident on each pixel;
an image generation section that builds a second image according to the event signal in a case where a predetermined condition is satisfied by the event volume counted by the counting section; and
a calculation section that calculates a motion vector of the region of attention in the second image.

2. The information processing device according to claim 1,
wherein the setting section sets a plurality of the regions of interest,
the counting section counts the event volume of each of the regions of attention corresponding to a plurality of the regions of interest,
the image generation section builds the second image for each of the regions of attention corresponding to a plurality of the regions of interest according to a timing to satisfy the predetermined condition, and
the calculation section calculates the motion vector of each of the regions of attention corresponding to a plurality of the regions of interest.

3. The information processing device according to claim 1,
wherein the setting section sets link information regarding a plurality of the regions of interest according to a mutual relation between a plurality of the regions of interest, and
the calculation section corrects the motion vector in accordance with the link information.

4. The information processing device according to claim 1,
wherein the event volume indicates the number of event signals per unit time, and
the image generation section builds the second image according to the event signals in a case where a predetermined threshold is exceeded by the number of event signals.

5. The information processing device according to claim 1,
wherein the calculation section calculates the motion vector according to time required for the event volume counted by the counting section to satisfy a predetermined condition.

6. The information processing device according to claim 1,
wherein the setting section updates the region of interest by referencing the motion vector.

7. The information processing device according to claim 1,
wherein the object is a person,
the detection section calculates coordinate information regarding at least one joint of the person, and
the setting section sets the region of interest for each joint of the person.

8. A system comprising:
a frame-based vision sensor;
an event-based sensor that asynchronously generates an event signal upon detection of a change in intensity of light incident on each pixel; and
an information processing device that includes
a detection section that detects an object according to a first image obtained using the frame-based vision sensor,
a setting section that sets, in the first image, at least one region of interest including at least a portion of the object,
a counting section that counts event volume of the event signal in a region of attention corresponding to the region of interest,
an image generation section that builds a second image according to the event signal in a case where a predetermined condition is satisfied by the event volume counted by the counting section, and
a calculation section that calculates a motion vector of the region of attention in the second image.

9. An information processing method comprising:
an acquisition step of acquiring a first image obtained using a frame-based vision sensor;
a reception step of receiving an event signal generated by an event-based sensor that asynchronously generates the event signal upon detection of a change in intensity of light incident on each pixel;
a detection step of detecting an object according to the first image;
a setting step of setting, in the first image, at least one region of interest including at least a portion of the object;
a counting step of counting event volume of the event signal in a region of attention corresponding to the region of interest;
an image generation step of building a second image according to the event signal in a case where a predetermined condition is satisfied by the counted event volume; and
a calculation step of calculating a motion vector of the region of attention in the second image.

10. An information processing program that causes a computer to implement functions of:
acquiring a first image obtained using a frame-based vision sensor;
receiving an event signal generated by an event-based sensor that asynchronously generates the event signal upon detection of a change in intensity of light incident on each pixel;
detecting an object according to the first image;
setting, in the first image, at least one region of interest including at least a portion of the object;
counting event volume of the event signal in a region of attention corresponding to the region of interest;
building a second image according to the event signal in a case where a predetermined condition is satisfied by the counted event volume; and
calculating a motion vector of the region of attention in the second image.

11. A computer system comprising:
at least one memory for storing a program code; and
at least one processor for processing the program code to perform operations that include
acquiring a first image obtained using a frame-based vision sensor,
receiving an event signal generated by an event-based sensor that asynchronously generates the event signal upon detection of a change in intensity of light incident on each pixel,
detecting an object according to the first image,
setting, in the first image, at least one region of interest including at least a portion of the object,
counting event volume of the event signal in a region of attention corresponding to the region of interest,
building a second image according to the event signal in a case where a predetermined condition is satisfied by the counted event volume, and
calculating a motion vector of the region of attention in the second image.
